(19) United States
(12) Patent Application Publication
(10) Pub. No.: US 2012/0218533 A1
(43) Pub. Date: Aug. 30, 2012

(54) METHOD OF CALCULATING MODEL PARAMETERS OF A SUBSTRATE, A LITHOGRAPHIC APPARATUS AND AN APPARATUS FOR CONTROLLING LITHOGRAPHIC PROCESSING BY A LITHOGRAPHIC APPARATUS

(75) Inventors: Irina LYULINA, Son (NL); Hubertus Johannes Gertrudus Simons, Venlo (NL); Manfred Gawein Tenner, Eindhoven (NL); Pieter Jacob Heres, Veldhoven (NL); Marc Van Kemenade, Waalre (NL); Daan Maurits Slotboom, Rhenen (NL); Stefan Cornelis Theodorus Van Der Sanden, Nijmegen (NL)

(73) Assignee: ASML NETHERLANDS B.V., Veldhoven (NL)

(21) Appl. No.: 13/403,538

(22) Filed: Feb. 23, 2012

Related U.S. Application Data
(60) Provisional application No. 61/446,795, filed on Feb. 25, 2011.

(51) Int. Cl. G03B 27/53; G06F 17/10

(52) U.S. Cl. 355/53; 703/2

(57) ABSTRACT

Estimating model parameters of a lithographic apparatus and controlling lithographic processing by a lithographic apparatus includes performing an exposure using a lithographic apparatus projecting a pattern onto a wafer. A set of predetermined wafer measurement locations is measured. Predetermined and measured locations of the marks are used to generate radial basis functions. Model parameters of said substrate are calculated using the generated radial basis functions as a basis function across said substrate. Finally, the estimated model parameters are used to control the lithographic apparatus in order to expose the substrate.

### CROSS REFERENCE TO RELATED APPLICATIONS

This application claims priority and benefit under 35 U.S.C. §119(e) to U.S. Provisional Patent Application No. 61/446,795, entitled “Method of calculating model parameters of a substrate within an apparatus and an apparatus for controlling lithographic processing,” filed on Feb. 25, 2011. The content of that application is incorporated herein in its entirety by reference.

### FIELD

The present invention relates to a method of calculating model parameters of a substrate, a lithographic apparatus and an apparatus for controlling lithographic processing by a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to expose successively exposed target portions exactly on top of each other the substrate will be provided with alignment marks to provide a reference location on the substrate. By measuring the location of the alignment marks the position of the previously exposed target portions can be calculated and the lithographic apparatus can be controlled to expose the successive target portion exactly on top of a previously exposed target portion.

To determine the position of previously exposed target portions with the required accuracy it may be advantageous to estimate model parameters of the substrate. In the past, it may have been sufficient to use only linear models to expose successively target portions with the required overlay specifications on top of each other. The non-linear terms however may be the largest contributors to overlay errors. Latest developments also allow to measure more alignment marks per substrate. The accuracy of a linear model may not improve with more alignment marks. A more sophisticated model may therefore be needed.

### SUMMARY

It is desirable to calculate model parameters of a substrate. According to a first aspect of the invention, there is provided a method of calculating model parameters of a substrate in an apparatus, the method comprising the steps of measuring locations of marks on the substrate in the apparatus; using measured locations of the marks to generate radial basis functions, and calculating model parameters of said substrate within said apparatus using the generated radial basis functions as a basis function across said substrate.

With the calculated model parameters a location on a substrate on a substrate table may be determined by interpolation more precisely to minimize overlay errors of substrates exposed in the apparatus. The method may also be used to calculate model parameters of a first and second substrate table in an apparatus to minimize overlay errors, for example for so-called chuck to chuck calibration. The method may also be used to calculate model parameters of a first and second apparatus in a factory, for example for so-called machine to machine calibration, wherein a first and second apparatus in a factory are calibrated to minimize overlay errors. The method may also be used for machine setup.

According to a second aspect of the invention, there is provided a lithographic apparatus arranged to perform a lithographic process across a substrate and to control the lithographic process, said apparatus comprising a processor which is configured to: receive measurement locations of marks on the substrate in the lithographic apparatus; use measured mark locations to generate radial basis functions; calculate model parameters of said substrate in said lithographic apparatus using said radial basis functions as a basis function across said substrate, and control the lithographic process by said lithographic apparatus using said model parameters.

According to a third aspect of the invention, there is provided an apparatus arranged to: control lithographic processing by a lithographic apparatus and to perform a lithographic process across a substrate, said apparatus comprising a processor which is configured to receive measurement locations of marks on the substrate in said apparatus; use measured mark locations to generate radial basis functions; calculate model parameters of said substrate in said apparatus using said radial basis functions as a basis function across said substrate, and control lithographic processing by said lithographic apparatus using said model parameters.

The invention may be applied to a lithographic apparatus or to an apparatus which may be used to control lithographic processing by a lithographic apparatus and to perform a lithographic process across a substrate, such as a track (a tool that typically applies a layer of resist to a substrate and develops the exposed resist), a metrology tool and/or an inspection tool (e.g. a SEM/TEM).

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus;

FIG. 2 depicts a substrate layout and radial distances of several points on a substrate with respect to a center, and

FIG. 3 depicts several layouts of exposure fields with 5, 9 and 25 anchor points.

### DETAILED DESCRIPTION

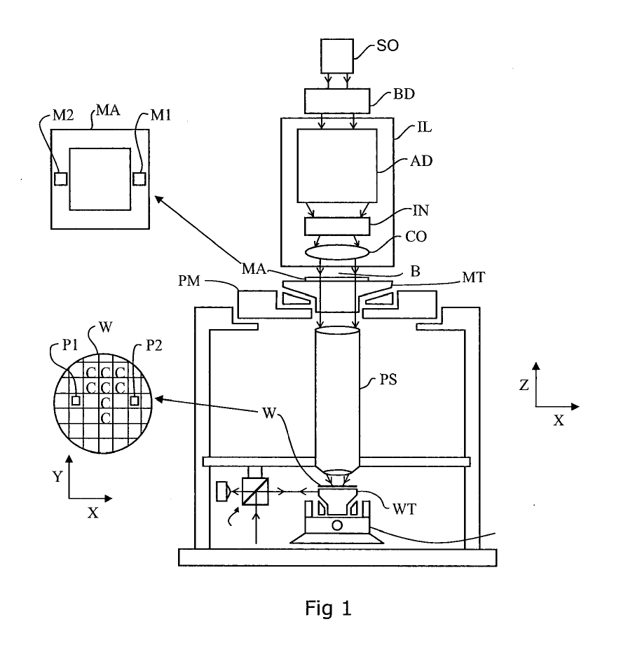

FIG. 1 schematically depicts a lithographic apparatus. The apparatus comprises:
an illumination system (illuminator) IL configured to condition a radiation beam B (e.g. UV radiation or DUV radiation).
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PL configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as r-outer and o-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PL, which focuses the beam onto a target portion C of the substrate W. With the aid of the second positioner PW and position sensor IF (e.g. an interferometric device, linear encoder, 2-D encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the x and/or y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In order that the substrates exposed by the lithographic apparatus are exposed correctly and consistently, it is desirable to determine the positions of the pre-exposed marks on the substrate. It is therefore necessary to measure the location of for example N pre-exposed marks on the substrate within the apparatus. To get the displacement of every mark the predetermined mark locations (that were determined at the exposure of pre-exposed layers on the substrate) may be subtracted from the measured location of the mark. The displacements of the marks may be used to predict the displacement in every point on the substrate. The displacement may therefore be described in terms of translation, magnification and rotation of every mark in a linear 6 parameter model.

For each measurement (of one alignment mark) an equation can be formed:

Mwx·xc−Rwy·yc+Cwx=dx

Rwx·xc+Mwy·yc+Cwy=dy

where xc and yc are the nominal positions where the measurement is done, w is a weighting coefficient which has a constant value here, and Cx (translation in x-direction), Cy (translation in y-direction), Mx (magnification in x direction), My (magnification in y direction), Rx (rotation of the x axis around the z axis) and Ry (rotation of the y axis around the z axis) are the model parameters to fit and dx, dy are the measured displacements (deviations) (measured position minus expected position). Writing these equations for every mark on the substrate leads to the following system:

$$[ \begin{matrix}d {x}_{i} \\ d {y}_{i}\end{matrix} ] = ⌈ \begin{matrix}1 & {xc}_{i} & - {yc}_{i} & 0 & 0 & 0 \\ 0 & 0 & 0 & 1 & {yc}_{i} & {xc}_{i}\end{matrix} ⌉ [ \begin{matrix}Cwx \\ Mwx \\ Rwx \\ Cwy \\ Mwy \\ Rwy\end{matrix} ]$$

$$i = 1 , … , N$$

In matrix vector notations it looks like A· x̅= b̅ and matrix A has size 2N×6.

This system can be easily split in two systems of size N×6 for the x and y directions:

$$[ \begin{matrix}1 & {x}_{1} & - {y}_{1} \\ ⋮ & ⋮ & ⋮ \\ 1 & {x}_{N} & - {y}_{N}\end{matrix} ] [ \begin{matrix}Cwx \\ Mwx \\ Rwx\end{matrix} ] = [ \begin{matrix}d {x}_{1} \\ ⋮ \\ d {x}_{N}\end{matrix} ]$$

$$and \\ [ \begin{matrix}1 & {y}_{1} & {x}_{1} \\ ⋮ & ⋮ & ⋮ \\ 1 & {y}_{N} & {x}_{N}\end{matrix} ] [ \begin{matrix}Cwy \\ Mwy \\ Rwy\end{matrix} ] = [ \begin{matrix}d {y}_{1} \\ ⋮ \\ d {y}_{N}\end{matrix} ] \\$$

To be able to find the model parameters to fit (Cwx, Cwy, Mwx, Mwy, Rwx and Rwy) at least 6 of these equations (i.e. 3 measurements) are needed. Normally, more measurements than parameters are available. This leads to solving an over-determined system of equations where the matrix has more rows than columns. A solution of these equations can be found using the well-known Least Square Method. This can be written as x̅=(A^{T}A)⁻¹A^{T} b̅.

The fit can be improved by adding more parameters to be fit. This is feasible if the number of measurements is larger than the number of parameters to be fitted. Radial basis functions (RBFs) may be used as a modern and powerful tool for function approximation and interpolation and extrapolation of scattered data in many directions. RBFs are real-valued functions whose value depend only on the distance from the origin, or alternatively on the distance from some other point, called center, so that:

φ(\vec{x}, \vec{c})=φ(∥\vec{x}−\vec{c}∥)=φ(r)

Function approximation with RBFs may be built in the form:

$$y ( {x}^{↼} ) = {\sum }_{i = 1}^{N} {w}_{i} φ ( ‖ \vec{x} - {\vec{c}}_{i} ‖ )$$

where the approximating function y(x) is be represented as a sum of N radial basis functions (RBFs), each associated with a different center c and weighted by an appropriate coefficient wᵢ and ∥·∥ is the notation for a standard Euclidean vector norm.

The weights wᵢ may be computed using the least square method in such a way that the interpolation conditions are met: Y(xᵢ)=yᵢ.

The linear system for the weight coefficients looks like:

$$[ \begin{matrix}{φ}_{11} & {φ}_{12} & {φ}_{1 N} \\ ⋮ & ⋮ & ⋮ \\ {φ}_{N 1} & {φ}_{N 2} & {φ}_{NN}\end{matrix} ] [ \begin{matrix}{w}_{1} \\ ⋮ \\ {w}_{N}\end{matrix} ] = [ \begin{matrix}{y}_{1} \\ ⋮ \\ {y}_{N}\end{matrix} ]$$

where φᵢⱼ=φ(rᵢⱼ) and rᵢⱼ is the distance between two points (e.g. the distance between two marks).

It may be noted that there are as many weight coefficients, i.e. degrees of freedom, as there are interpolation conditions. The resulting system of equations is non-singular (invertible) under very mild conditions and therefore a unique solution exists. For many of the radial basis functions (RBFs) the only restriction is that at least 3 points are not on a straight line.

Numerous choices for RBFs are possible, such as Gaussian basis functions, inverse basis functions, multiquadratic basis functions, inverse quadratic basis functions, spline degree k basis functions and thin plate spline basis functions. It is noted that also other RBFs are possible. Two major RBF classes are given below: infinitely smooth (whose derivatives exist at each point) and splines (whose derivatives may not exist in some points).

| Piecewise smooth RBF | Infinitely smooth RBF |
|---|---|
| Polyharmonic splines: | Gaussian: φ(r) = exp(−βr²) |
| φ(r) = r^{k} ln(r), k even, k ∈ N | Multiquadric: φ(r) = \sqrt{r² + β²} |
| φ(r) = r^{k}, k odd, k ∈ N | Inverse quadratic: φ(r) = (1 + βr²)⁻¹ |
| Generalized Duchon spline: | |
| φ(r) = r^{2v}, v ∉ N | |

The question which basis function to choose for substrate alignment models and with which parameters β, k, ν needs to be investigated in more detail. For k=2 the polyharmonic spline is called thin plate spline (TPS). This name refers to a physical analogy involving the bending of a thin sheet of metal. In the physical setting, the deflection is in the z direction, orthogonal to the plane of the thin sheet. In order to apply this idea to the problem of substrate deformation in a lithographic process we can interpret the lifting of the plate as a displacement of the x or y coordinates within the plane. TPS has been widely used as a non-rigid transformation model in image alignment and shape matching. The popularity of TPS comes from a number of advantages:
1. the model has no free parameters that need manual tuning, automatic interpolation is feasible;
2. it is a fundamental solution of the two-dimensional biharmonic operator,
3. given a set of data points, a weighted combination of thin plate splines centered around each data point gives the interpolation function that passes through these points exactly while minimizing the so-called “bending energy.”

Other possible choices that give good, accurate function approximations include the infinitely smooth RBFs multiquadric RBFs and Gaussian RBFs. Since the Gaussian radial basis function is so well localized in space, the parameter β in it should normally be dependent on the distances between the points within a given dataset; otherwise approximations are unlikely to deliver useful results, especially if the parameter is much too large in comparison with an average distance between the points. Multiquadric RBFs are also interesting to test, they give invertible matrices for all sets of distinct centers and all parameters, as do indeed the Gaussians, but the latter have the additional strong advantage that they give a positive definite, essentially banded interpolation matrix. In fact, the banded structure of the matrix becomes more dominant if the parameter in the Gaussian radial function is large, but this parameter pits locality against the accuracy of the approximation. This typical trade-off between locality and quality of the approximant should be addressed while choosing the RBF for substrate alignment models. Furthermore, more special radial functions are now being proposed in the literature that also give positive definite matrices and have genuinely banded interpolation matrices. An example for 2D is given by:

$$φ ( r ) = \frac{1}{18} - {r}^{2} + \frac{4}{9} {r}^{3} + \frac{1}{2} {r}^{4} - \frac{4}{3} {r}^{3} log r .$$

During fine substrate alignment N marks on a substrate are measured, and the displacement of every mark is determined. Based on this information the displacement of any point on the substrate can be predicted. The displacement of an arbitrary point on a substrate in the x direction is defined as dx and in the y direction as dy. FIG. 2 depicts a substrate layout and radial distances of several points on a substrate with respect to a center. Exploring the idea of RBF the following formula may be constructed to compute the displacement:

$$d x ( x , y ) = {a}_{1} + {a}_{2} x + {a}_{3} y + {\sum }_{i = 1}^{N} {w}_{i} φ ( ‖ ( x , y ) - ( {x}_{i} {y}_{i} ) ‖ ) \\ r = \sqrt{{( x - {x}_{i} )}^{2} + {( y - {y}_{i} )}^{2}} \qquad ( 1 )$$

The weight coefficients wi and the linear coefficients a₁, a₂, a₃ are determined such that the function passes through N given points (called RBF centers) (xᵢ,yᵢ), i=1, . . . , N and fulfil the so-called orthogonality conditions:

$$0 = {\sum }_{i = 1}^{N} {w}_{i} , 0 = {\sum }_{i = 1}^{N} {w}_{i} {x}_{i} , 0 = {\sum }_{i = 1}^{N} {w}_{i} {y}_{i}$$

In matrix form the equations are:

$$[ \begin{matrix}K & P \\ {P}^{T} & O\end{matrix} ] [ \frac{\overline{w}}{a} ] = [ \begin{matrix}\overline{d} \\ 0\end{matrix} ]$$

$${w}_{i} - weights , φ - radial basis functions , \\ \overline{d} - displacement in ( {x}_{i} , {y}_{i} )$$

$${K}_{ij} = φ ( ‖ ( {x}_{i} , {y}_{i} ) - ( {x}_{j} , {y}_{j} ) ‖ )$$

and O is the zero matrix.

$$P = [ \begin{matrix}1 & {x}_{1} & {y}_{1} \\ 1 & {x}_{2} & {y}_{2} \\ 1 & … & … \\ 1 & {x}_{N} & {y}_{N}\end{matrix} ] , w = [ \begin{matrix}{w}_{1} \\ {w}_{2} \\ \\ {w}_{N}\end{matrix} ] , d = [ \begin{matrix}{d}_{1} \\ {d}_{2} \\ \\ {d}_{N}\end{matrix} ] , a = [ \begin{matrix}{a}_{1} \\ {a}_{2} \\ {a}_{3}\end{matrix} ]$$

The main approximation formula (1) consists of 2 parts: a polynomial part and a linear combination of radial basis functions. In many applications the extra polynomial term is included in the approximation formulae to improve conditioning and to ensure non-singularity of the interpolation matrix. This first order polynomial term represents a global affine component of approximation and the RBF term represents a local non-affine component. The polynomial part is especially useful if extrapolation occurs, so it improves the accuracy of approximation close to the edge of the wafer. To summarize: at a first step the locations of the marks on a substrate within the lithographic apparatus are measured; using the predetermined and measured locations of the marks radial basis functions are generated, and model parameters such as weight coefficients wᵢ and linear coefficients a₁, a₂, a₃ in x and y directions are calculated using the generated radial basis functions as a basis function across said substrate. At a second step the displacement of every exposure field is computed using these model parameters.

A potential problem of exact interpolation in substrate alignment may be caused by the absence of residuals in this model. In general residuals may be used for the detection of outliers and for the computation of different performance coefficients.

One of the solutions of this potential problem is to use the linear part of the RBF model (see equation (1)) to compute residuals. Another possible solution is to relax the interpolation requirements slightly thus allowing the resulting interpolation surface not going exactly through the measured points. This solution is using a process of relaxation which is controlled by a relaxation parameter λ. If λ is zero, the interpolation may be exact and if λ approaches infinity, the resulting surface may be reduced to a least squares fitted plane.

The relaxation parameters will appear in diagonal of matrix K

$${K}_{ij} = φ ( ‖ ( {x}_{i} , {y}_{i} ) - ( {x}_{j} , {y}_{j} ‖ ) + {I}_{ij} {α}^{2} λ \\ α = \frac{1}{{N}^{2}} {\sum }_{i = 1}^{N} {\sum }_{j = 1}^{N} {r}_{ij}$$

where I is a standard unit diagonal matrix and α is the mean of distances between the measurement points. This extra parameter α makes the relaxation parameter λ scale invariant.

In matrix form the equations now are:

$$[ \begin{matrix}K + {α}^{2} λ I & P \\ {P}^{T} & O\end{matrix} ] [ \frac{\overline{w}}{a} ] = [ \begin{matrix}\overline{d} \\ 0\end{matrix} ]$$

An important question may be how an RBF model will behave if outliers may be present in the measurement data. While using RBFs it might be necessary to provide an algorithm for outlier removal. As mentioned before, two possible solutions are identified for the RBF model to compute residuals, i.e. by using the linear part of the RBF model or by using a relaxation process.

Smaller relaxation parameters may give smaller residuals. Residuals of neighboring points may be effected by the relaxation process. The smaller the relaxation parameter λ the more difficult it may be to set the threshold for the removal of outliers. It may happen that in case of inappropriate choice of the relaxation parameter λ good neighboring data points may be removed. At the other hand a smaller relaxation parameter λ gives a better modeling accuracy, but still not better than the modeling accuracy that will be achieved when using the RBF model without the relaxation process. Based on these considerations, the preference is for 6 parameters residuals. The residuals from the linear part of the RBF model may be used for outlier detection, color selection (i.e. for the selection of the alignment signal having the best signal to noise ratio) and for computation of different performance indicators.

With the previously described approach all measurement points will be equally relaxed, but on basis of additional info (e.g. color selection of the alignment signal, diffraction order of the alignment signal, noise information) the measurement points can be relaxed differently. They can for example be relaxed proportionally to chosen performance indicator. For this specific situation it is necessary to define the relaxation parameter λ per measurement point:

$${K}_{ij} = φ ( ‖ ( {x}_{i} , {y}_{i} ) - ( {x}_{j} , {y}_{j} ‖ ) + {I}_{ij} {α}^{2} {λ}_{i} \\ α = \frac{1}{{N}^{2}} {\sum }_{i = 1}^{N} {\sum }_{j = 1}^{N} {r}_{ij} .$$

When applying a relaxation per measurement point the model accuracy will improve because good marks will contribute more to the model than less reliable marks.

When applying high order wafer alignment models such as the RBF model, it is may not be sufficient to control only the center positions of an exposure field with an interfield model. To ensure best fit of the exposure field on the local substrate area, the intrafield parameters (magnification and rotation, symmetric and asymmetric) may be computed. This may be done during the exposure sequence. For this reason at each exposure, not only the position of the center of the exposure field (i.e. target portion on the substrate) may be determined using substrate alignment models, but also additional positions called anchor points.

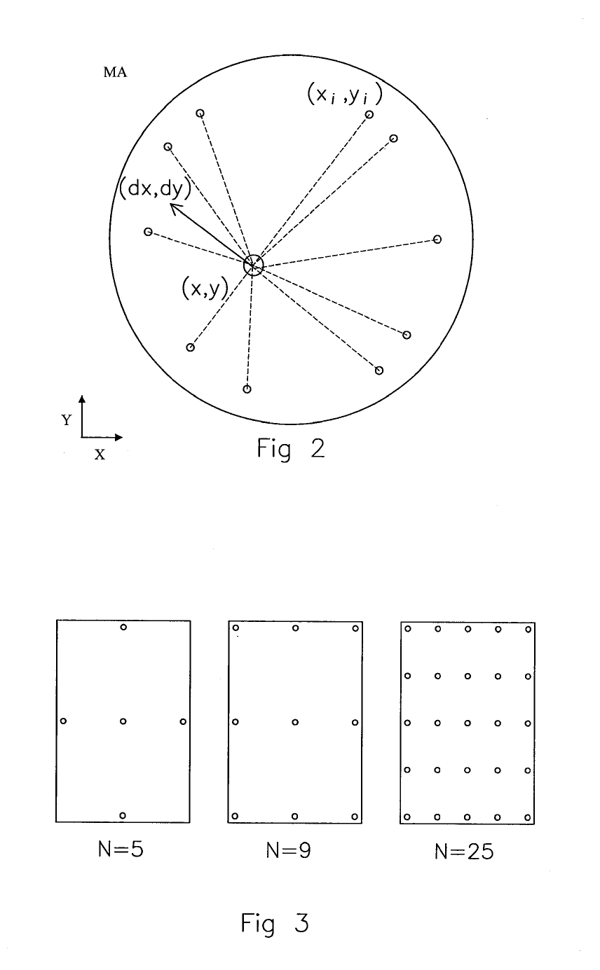

There are several options for placement of the anchor points. If the exact field size of the target portion on the substrate is not known at metrology level, arbitrary positions can be used. For example, 5 anchor points may be used at 5 mm pitch. These locations may not be optimal because the field size may be different in x and y. In FIG. 3 several layouts for an exposure filed are given with 5, 9 and 25 anchor points. Another way for placement of the anchor points is to define the anchor points along the perimeter of the field. Three steps may be distinguished:
1. Anchor points may be chosen around the center of the exposure field
2. For each anchor point a displacement may be calculated using one of the models (e.g. RBF model)
3. Based on the deformation of all anchor points, the field parameters translation in x Tx, translation in y Ty, symmetrical field magnification Ms, asymmetrical field magnification Ma, symmetrical field rotation Rs and asymmetrical field rotation Ra may be calculated using a linear model.

At step 3 the linear system A· x̅= b̅ needs to be solved wherein the matrix A has size 2n×6, where n is number of anchor points. The matrix A may be only depending on the layout of the anchor points and may therefore be the same for all fields. This gives the opportunity to calculate the pseudo-inverse of this matrix once, and use it for calculating the field parameters of each exposure. The field parameters may be used during exposure of the exposure field to minimize overlay errors with respect to a previous exposed exposure field.

The process of substrate alignment may be considered to be a major contributor to the overlay errors. An optimization of the substrate alignment process may therefore be important to minimize the overlay errors. One aspect of that optimization is finding an optimal mark layout. Mark selection algorithms may be optimal for linear models. However, overlay requirements may require non-linear models.

A possible automatic mark selection algorithm currently spreads the marks in an area on the substrate limited by two radii. In this approach, a memory stores the locations of one or more sets of substrate alignment marks or overlay metrology targets available for selection and selection rules are used to select suitable substrate alignment marks or overlay metrology targets from this at least one set. The selection rules are based on experimental or theoretical knowledge about which substrate alignment mark or overlay metrology targets locations are optimal in dependence on one or more selection criteria.

The above referred possible automatic mark selection algorithm software spreads the marks in an area on the substrate limited by two radii. The distribution of marks yielding from this approach lacks a good spatial distribution. As a result higher order polynomials that are fitted over these data points, tend to overcorrect at the edge of the substrate.

Another possible automatic mark selection algorithm first generates a lot of possible mark layouts before it decides which layout is optimal. In general, such an approach can tend to be computationally expensive and time consuming. In the case where there are many marks to select from, this Monte Carlo like approach may prove impractical be used if immediate response is required.

The idea underlying this automatic mark selection algorithm is the use of a Voronoi diagram. In a Voronoi diagram a mark represents the substrate deformation of the area around that mark. So, ideally one would like to have a nicely spread distribution of equally sized areas around one point in a Voronoi diagram. In a Voronoi diagram the borders of the areas are defined as a line with equal distance towards two points.

For the actual mark selection algorithm it is not needed to calculate the full Voronoi diagram for each selection. Since there is only a limited set of points (marks or fields) to select from, one can simply run over all points and calculate the distance to the already selected set. The minimum of all these distances represents the distance to the whole set. A mark may be selected when it has the largest minimum distance to all already selected points. This principle is also called the “Nearest Neighbour Principle”. Alternatively, a mark may be selected on the basis of the sum of all distances to the selected set.

The schematic outline of the algorithm:
1. Choose initial point e.g. a point close to the centre of the substrate
2. Add other points until requested number is reached using the following criteria:
   point with largest minimum distance from selected set, or
   point that minimize potential energy of selected set (sum of one over distances squared)

$${U}_{pot} = min {\sum }_{j} \frac{1}{{d}_{j}^{2}}$$

One of the features of the algorithm may be that it may produce symmetric layouts e.g. a mark layout that may be symmetric in the x-axis and y-axis through the center of the wafer. To keep the mark layout symmetric, all marks mirrored into the axis through the center of the mark layout may be added as well.

In the first stages of the algorithm the center of the mark layout may be found. For this purpose, first the edge of the layout may be found and the center may be defined relative to the edge.

Because of possible deformations of the edge of the substrate, the edge can be added to the layout. One of the properties of the Voronoi-like algorithm is that parts of the edge may be automatically selected in an early stage of the algorithm, since the edge of the substrate is the most far away from the center. Nevertheless, with the Voronoi-like algorithm it may be possible to explicitly add the edge to the mark layout from the beginning. The Voronoi-like algorithm includes the following steps:
1. Find the edge of the full set of marks
   a. For a large number of marks on the edge of the wafer, the field/point may be searched that is closest. The edge fields may be defined as a subset of all these points.
   b. If specified, add the edge to the mark selection
2. Find the center of the full set of marks
   a. The center is defined as the center of the edge. Based on the place with the center is with respect to the fields 1, 2 or 4 marks/fields may be added to the mark selection
3. Add additional points with maximum minimum distance or sum of all distances until requested number may be reached
   a. When one point with max-min distance or sum distance may be found, the 4 mirrored points are also added to the mark selection

The algorithm allows an operator of a lithographic machine to select a large number of marks automatically, marks selected from its own production layout. Furthermore, the algorithm is user independent. Advantages of this algorithm may be that it is fast and simple and it provides a symmetric layout with good substrate coverage.

For a large amount of points to select from, the algorithm can find an optimal selection within reasonable time. The layout may be symmetric around the center of the wafer. The marks are selected equidistantly, so good spatial distribution is guaranteed. In this way, the algorithm gives an optimal layout, given the number of points to select and the model to be used.

A good mark selection, in combination with a good model for wafer deformations, may enable to improve the overlay on lithography machines in general.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A method of calculating model parameters of a substrate in an apparatus, the method comprising:
measuring locations of marks on the substrate in the apparatus;
using measured locations of the marks to generate radial basis functions; and,
calculating model parameters of said substrate in said apparatus using the generated radial basis functions as a basis function across said substrate.

2. The method according to claim 1, wherein using measured locations of the marks comprises using predetermined and measured locations of the marks.

3. The method according to claim 1, wherein said radial basis function is selected from the group consisting of: a Gaussian basis function, an inverse basis function, a multiquadratic basis function, an inverse quadratic basis function, a spline degree k basis function and a thin plate spline basis function.

4. The method according to claim 2, wherein the calculating model parameters of said substrate in the apparatus comprises:
constructing a matrix using said radial basis functions and said predetermined mark locations.

5. The method according to claim 1, wherein said predetermined mark locations are optimized to increase accuracy of said calculated model parameters.

6. The method according to claim 5, wherein said predetermined mark locations are optimized using an algorithm comprising a Voronoi diagram.

7. The method according to claim 1 wherein the radial basis function comprises a relaxation parameter.

8. The method according to claim 1 wherein the apparatus is a lithographic apparatus and the method further comprises:
performing a lithographic process using said lithographic apparatus across a substrate; and
controlling the lithographic process by said lithographic apparatus using said calculated model parameters.

9. The method according to claim 1, wherein the apparatus is a lithographic apparatus comprising first and second substrate tables and the method further comprises:
measuring locations of marks on the substrate on the first and second substrate table in the apparatus.

10. The method according to claim 9, wherein the method further comprises:
using measured locations of the marks on the substrate on the first and second substrate table to generate radial basis functions for the substrate on the first and second substrate table and,
calculating model parameters of said substrate on the first and second substrate table in said apparatus using the generated radial basis functions as a basis function across said substrate.

11. The method according to claim 9, wherein the method further comprises :
using measured locations of the marks on the substrate on the first substrate table and the measured locations of the marks on the second substrate table to generate radial basis functions for the difference between a substrate on the first and second substrate table; and,
calculating model parameters of the difference between a substrate on the first or second substrate table in said apparatus using the generated radial basis functions as a basis function across said substrate.

12. The method according to claim 1, wherein the apparatus is located in a factory comprising first and second apparatus with first and second substrate locations, the method comprising:
measuring locations of marks on the substrate on the first and second substrate locations;
using measured locations of the marks on the substrate on the first substrate locations and the measured locations of the marks on the second substrate location to generate radial basis functions for the difference between a substrate on the first or second substrate location; and,
calculating model parameters of the difference between a substrate on the first or second substrate location in said factory using the generated radial basis functions as a basis function across said substrate.

13. A lithographic apparatus arranged to perform a lithographic process across a substrate and to control the lithographic process, said apparatus comprising a processor which is configured and arranged to:
receive measurement locations of marks on the substrate in the lithographic apparatus; use measured mark locations to generate radial basis functions;
calculate model parameters of said substrate in said lithographic apparatus using said radial basis functions as a basis function across said substrate; and,
control the lithographic process by said lithographic apparatus using said model parameters.

14. An apparatus arranged to control lithographic processing by a lithographic apparatus and to perform a lithographic process across a substrate, said apparatus comprising a processor which is configured and arranged to:
receive measurement locations of marks on the substrate in said apparatus; use measured mark locations to generate radial basis functions;
calculate model parameters of said substrate in said apparatus using said radial basis functions as a basis function across said substrate; and,
control the lithographic process by said lithographic apparatus using said model parameters.

15. The apparatus according to claim 13, wherein said radial basis function is a Gaussian basis function, an inverse basis function, a multiquadratic basis function, an inverse quadratic basis function, a spline degree k basis function or a thin plate spline basis function.
